(19) United States
(12) Patent Application Publication
(10) Pub. No.: US 2025/0237436 A1
(43) Pub. Date: Jul. 24, 2025

(54) Multifunctional Indirectly Heated Rotary Kiln

(71) Applicant: Stephen Parker, Ringoes, NJ (US)

(72) Inventor: Stephen Parker, Ringoes, NJ (US)

(21) Appl. No.: 18/518,928

(22) Filed: Nov. 24, 2023

Related U.S. Application Data
(60) Provisional application No. 63/427,623, filed on Nov. 23, 2022.

(51) Int. Cl. F27B 7/42; F27B 7/08; F27B 7/18; F27B 7/26; F27B 7/33

(52) U.S. Cl. CPC F27B 7/42; F27B 7/08; F27B 7/18; F27B 7/26; F27B 7/33

(57) ABSTRACT

A multifunctional indirectly heated rotary kiln is provided to perform pyrolysis, calcining, roasting, thermal decomposition, and gasification for a variety of organic and inorganic feedstocks. The kiln operates over a temperature range from 100 degrees to 1,800 degrees Fahrenheit, can run in continuous or batch mode, and allows either co-current or counter-current operation. A feedstock is fed into a kiln and the thermally treated product is extracted. A plurality of paddles is provided at an interior surface of the kiln to allow maximum heat uptake by reactants through extended time in contact with the interior kiln walls. Feed screw and extraction screw assemblies are provided on portable carts to facilitate component swapping when a component becomes full or empty.

### CROSS-REFERENCE TO RELATED APPLICATIONS

This application claims priority to U.S. Provisional Application 63/427,623, filed on Nov. 23, 2022, the complete disclosure of which is incorporated herein by reference in its entirety.

### FIELD OF THE TECHNOLOGY

The technology relates to rotary kilns, more particularly to indirectly heated rotary kilns, and still more particularly to multifunctional indirectly heated rotary kilns providing tightly controlled thermal treatment of organic and inorganic feedstocks capable of operating in co-current and countercurrent modes for the purposes of drying, pyrolysis, gasification, calcining, roasting, and thermal decomposition.

### BACKGROUND OF THE TECHNOLOGY

Initially, rotating kilns were commercially employed to make cement by thermally processing materials when oil replaced producer gas and coal as fuel. Rotating kilns enabled process and product quality control. In addition to making cement, rotary kilns are now used to produce lime, refractory materials, metakaolin, titanium dioxide, alumina, vermiculite, iron ore pellets, along with a variety of other processed ore products. Conventional rotating kilns are directly fired and are significant industrial contributors to greenhouse gas emissions.

High temperature rotary kilns are further employed to manage municipal solid waste. In 1914. William Morley obtained a patent for a system that converted garbage into a non-putrescible product to manage municipal waste (U.S. Pat. No. 1,096,854 A). Over the past 100 years, numerous applications have been commercialized to manage municipal and industrial solid waste using rotary kilns in both co-current and counter-current configurations. These are operated in regimes ranging from pyrolysis to gasification to incineration.

Some waste is simply not suitable for reuse or recycling. In these cases, volume reduction by incineration in kilns was an acceptable approach to minimizing an amount of waste deposited in landfills or to converting hazardous waste to non-toxic material. However, incineration alone is not a best option if decreased greenhouse gas emissions and increased sustainability are desired. This is especially true when compared directly heating the processed materials to indirectly heating the processed materials.

Indirect heating significantly reduces emissions per unit mass of product generated and improves process thermal efficiency, whether a goal is to produce more sustainable fuels or other beneficial products such as activated carbon from biomass. Indirect heating is also beneficial for re-use of fossil-based material such as most plastics.

When an end-product is primarily a gaseous material, indirect firing generates a medium to high energy content fuel. In contrast, direct firing with air as the oxidant causes dilution with the remaining residual nitrogen after partial oxidation of the combustible fraction of the material processed. The resulting producer gas is typically low in calorific value, typically 90 to 140 Btu per standard cubic foot.

### BRIEF DESCRIPTION OF THE DRAWINGS

Implementations of the present technology will now be described, by way of example only, with reference to the attached figures, wherein:

FIG. 1 illustrates a cross-sectional side view of an indirectly heated rotary kiln provided within a housing, according to one example of the technology;

FIG. 2 illustrates a side view of the housing that receives the indirectly heated rotary kiln therein, according to one example of the technology;

FIG. 3 illustrates an end view of the housing in an open configuration with the indirectly heated rotary kiln therein, according to one example of the technology;

FIG. 4 illustrates an end view of the housing in a closed configuration with the indirectly heated rotary kiln therein and a feed screw assembly coupled thereto, according to one example of the technology;

FIG. 5 illustrates a cross-sectional end view of the housing in a closed configuration with the indirectly heated rotary kiln provided within, according to one example of the technology;

FIG. 6 illustrates a close-up cross-sectional side view of an end portion of the housing in a closed configuration with the feed screw assembly coupled to the indirectly heated rotary kiln for introducing material into the rotary kiln, according to one example of the technology;

FIG. 7 illustrates a close-up cross-sectional side view of an end portion of the housing in a closed configuration with an extraction screw assembly coupled to the indirectly heated rotary kiln for removing material from the rotary kiln, according to one example of the technology;

FIG. 8 illustrates a close-up cross-sectional side view of an end portion of the housing in a closed configuration with a combined feed and extraction screw assembly coupled to the indirectly heated rotary kiln for introducing material into and extracting material from the rotary kiln, according to one example of the technology;

FIG. 9 illustrates an end view of the indirectly heated rotary kiln provided within the housing in a closed configuration with stabilizing rollers supporting the weight of the rotary kiln via annular pipes provided at the center of the rotary kiln, according to one example of the technology;

FIG. 10 illustrates an end view of a large indirectly heated rotary kiln provided within the housing in a closed configuration with stabilizing rollers supporting the weight of the rotary kiln via a support provided along a circumference of the rotary kiln, according to one example of the technology;

FIG. 11 illustrates a cross-sectional side view of the large indirectly heated rotary kiln provided within the housing in a closed configuration, according to one example of the technology; and

FIG. 12 illustrates a flow chart for processing biochar via a plurality of processes.

### DETAILED DESCRIPTION OF THE TECHNOLOGY

It will be appreciated that for simplicity and clarity of illustration, where appropriate, reference numerals may be repeated among the different figures to indicate corresponding or analogous elements. In addition, numerous specific details are set forth in order to provide a thorough understanding of the examples described herein. However, it will be understood by those of ordinary skill in the art that the examples described herein can be practiced without these specific details. In other instances, methods, procedures, and components have not been described in detail so as not to obscure the related relevant feature being described. Also, the description is not to be considered as limiting the scope of the examples described herein. The drawings are not necessarily to scale and the proportions of certain parts may have been exaggerated to better illustrate details and features of the present disclosure. Those skilled in the art with access to the teachings provided herein will recognize additional modifications, applications, and examples within the scope thereof and additional fields in which the technology would be of significant utility.

Unless defined otherwise, technical and scientific terms used herein have the same meaning as is commonly understood by one of ordinary skill in the art to which this disclosure belongs. The terms “first,” “second,” and the like, as used herein do not denote any order, quantity, or importance, but rather are used to distinguish one element from another. Also, the terms “a” and “an” do not denote a limitation of quantity, but rather denote the presence of at least one of the referenced items. The term “or” is meant to be inclusive and means either, any, several, or all of the listed items. The terms “comprising,” “including,” and “having” are used interchangeably in this disclosure. The terms “comprising,” “including,” and “having” mean to include, but are not necessarily limited to the things so described.

The terms “connected” and “coupled” are not restricted to physical or mechanical connections or couplings, and can include electrical connections or couplings, whether direct or indirect. The connection can be such that the objects are permanently connected or releasably connected. The term “communicatively coupled” is defined as connected, either directly or indirectly through intervening components, and the connections are not necessarily limited to physical connections, but are connections that accommodate the transfer of data, signals, or other matter between the so-described components. The term “substantially” is defined to be essentially conforming to the thing that it “substantially” modifies, such that the thing need not be exact. For example, substantially real-time means the occurrence may happen without noticeable delay, but may include a slight delay.

The terms “circuit,” “circuitry,” and “controller” may include either a single component or a plurality of components, which are either active and/or passive components and may be optionally connected or otherwise coupled together to provide the described function. The “processor” described in any of the various examples includes an electronic circuit that can make determinations based upon inputs and is interchangeable with the term “controller.” The processor can include a microprocessor, a microcontroller, and a central processing unit, among others, of a general purpose computer, special purpose computer, ASIC, or other programmable data processing apparatus. While a single processor can be used, the present disclosure can be implemented over a plurality of processors.

It is understood that each block of the block diagrams or operational illustrations, and combinations of blocks in the block diagrams or operational illustrations, can be implemented with analog or digital hardware and computer program instructions. The computer program instructions may be provided to a processor that executes the computer program instructions to implement the functions/acts specified in the block diagrams or operational block or blocks. In some alternative implementations, the functions/acts noted in the blocks may occur out of the order noted in the operational illustrations. For example, two blocks shown in succession may, in fact, be executed substantially concurrently or the blocks may sometimes be executed in the reverse order, depending upon the functionality/acts involved.

The technology described herein is directed to indirectly heated rotary kilns. For example, indirectly fired rotary kilns that process materials in an inert environment. According to one example, the material introduced into the kiln does not contact the process gas. Rather, the kiln is enveloped in a heat shroud or housing and heated from the outside. According to one example, the material is heated via contact with a hot kiln body. Indirectly heated rotary kilns may be employed in applications that require a tightly controlled environment. Indirectly heated rotary kilns provide precise temperature control along a length of the kiln. According to one example, a material may be brought up to a desired temperature and held at the desired temperature for a specific amount of time as the material moves through the kiln.

According to one example, fuel gas is a combustible gas that may exit the kiln. Fuel gas may contain hydrocarbons; sulfur containing gases such as hydrogen sulfide and other gases; nitrogen containing gaseous species such as ammonia and other gases; halide containing gaseous species such as hydrochloric acid and other gases; and particulates. The particulates are commonly known as bed solids and entrained solids when exiting the kiln.

According to one example, the technology described herein includes a rotating kiln that processes organic and non-organic materials in a temperature range of 100° F. to 1800° F. The technology receives and converts waste material to produce a fuel gas and a solid product. For example, the rotating kiln may receive solid waste material such as municipal solid waste, refuse derived fuel, wood products, plastics, tire derived fuel, sorted construction and demolition waste, medical, and/or hazardous waste. According to one example, the rotating kiln may receive a mixture of waste materials or fuels. According to one example, the rotating kiln may receive biochar that is processed into activated carbon. According to one example, the rotating kiln may be fed by a mixture of waste derived fuels and biochar. According to one example, temperatures along a length of the kiln may be controlled to react all the biochar. According to one example, temperatures along the length of the kiln may be controlled to raise a temperature for drying the feedstock, performing pyrolysis, and performing steam activation.

According to one example, kiln performance may be controlled by a combination of design geometry, internal plate configurations, internal paddle configurations, regulating feedstock composition, rotation rate, and feed rate, among other parameters. According to one example, the material feed rate may be established in proportion to a per unit mass of moisture and waste fed, per unit moisture content, and per unit feedstock species, or the like. According to one example, a peak solids temperature may be set in the kiln below a fusion point, but above a temperature range where steam and fixed carbon reactions occur. According to one example, the technology transfers sufficient enthalpy from the combustion zones via radiation, conduction, and convection to sustain drying of the moisture and pyrolysis of the feedstock.

The technology provides a multifunctional indirectly heated rotary kiln that offers a range of applications for heat treatment of a variety of organic and inorganic feedstocks in the areas of drying, pyrolysis, calcining, roasting, thermal decomposition, and gasification, among other heat treatments. The technology provides easy process integration with upstream and downstream processing and achieves higher efficiency than most directly heated kilns. The technology is less sensitive to feedstock quality variations and enables decentralized feedstock processing. These improvements save energy and provide reduced greenhouse gas emissions by minimizing materials transport costs for feedstock acquisition and product distribution.

According to one example, technology operates in co-current or counter current modes. During co-current operation, the generated gas phase material moves through the rotary kiln in a same direction as the solid-state feedstock or product materials. For example, gases and feedstock may be introduced into a feed end of the rotary kiln. The processed material may be extracted from a discharge end, along with volatiles or gas phase reaction products. During counter-current operation, the gas flows in an opposite direction to the solid-state feedstock flow. Counter-current operation may be preferred when the primary or most valued product is a solid phase product. The kiln transfers sufficient enthalpy indirectly to sustain drying of the moisture and devolatilization of the volatile matter in the waste feed.

According to one example, the rotary kiln may operate in continuous or batch modes. This results from an ability to inject or remove gasses from either end of the rotary kiln through a flow path annular that is fluidly coupled to a feed screw assembly having a feedstock charging screw or an extraction screw assembly having a product discharging screw. According to one example, a batch mode is a closed process. Once the process starts, the kiln is sealed and no additional feedstock material is added. In contrast, feedstock material is continuously fed into a kiln operating in continuous mode. The technology may operate without direct addition of a reactant gas required with the withdrawal of gaseous product from either end, depending upon which mode produces an optimal combined product slate of vapor and solid products.

According to one example, the rotary kiln may be indirectly heated with a plurality of gas or liquid fuel fired burners. In addition, or alternatively, the rotary kiln may be indirectly heated by electrical resistive heating elements arrayed in a variety of patterns inside the refractory lined steel case or outer housing, according to process requirements. Heating operations may be controlled by a quantity of fuel gas supplied to the burners or an amount of electrical current provided to the respective elements. Furthermore, heating or cool down operations may be controlled by adjusting a damper in the exhaust stack affixed to the cover of the outer housing.

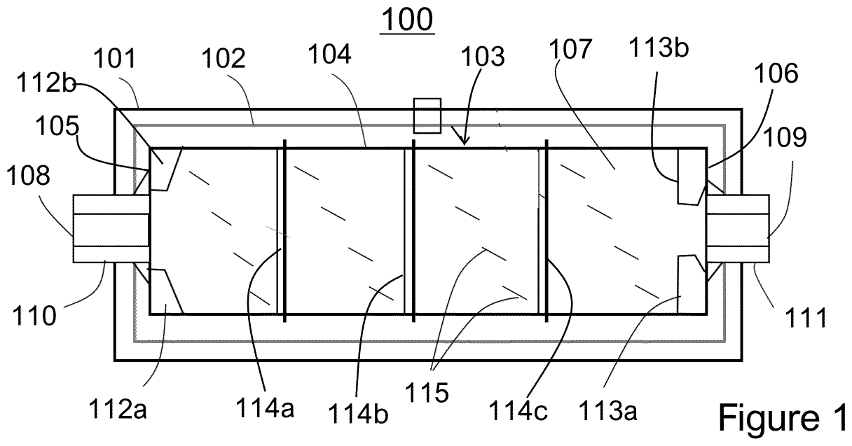

FIG. 1 illustrates a cross-sectional view of an apparatus 100 according to one example of the technology. According to one example, the apparatus 100 may include an outer housing 101 that envelopes a rotary kiln 103 therein. According to one example, the rotary kiln 103 may be a tubular chamber. According to one example, the outer housing 101 may include insulation 102. For example, the insulation 102 may include a layer of ceramic fiber refractory insulation 102 or the like provided over an inside surface. According to one example, the insulation 102 may be rated at 2,300° F., among other temperature ratings. According to one example, the outer housing 101 may be constructed of carbon steel or the like. According to one example, the rotary kiln 103 may be constructed from materials that are selected according to desired operating temperatures. For example, the rotary kiln 103 may be constructed from high temperature stainless steel or Inconel materials.

According to one example, the rotary kiln 103 may include a body 104 that together with ends 105,106 define a cavity 107. According to one example, the rotary kiln 103 may include reduced access openings at each end 105,106 to feed and discharge the process or product materials. For example, a first end 105 may include an inlet pipe 108 that deposits feedstock material into the cavity 107. Furthermore, a second end 106 may include an outlet pipe 109 that expels product material from the cavity 107. According to an alternative example, one of the ends 105,106 may include a pipe that performs both material delivery and material recovery. According to one example, the ends 105,106 may include concentric pipes. For example, the first end 105 may include inlet pipe 108 and a first outer pipe 110. Similarly, the second end 106 may include outlet pipe 109 and a second outer pipe 111.

According to one example, the concentric pipe assemblies are engineered to support a weight of the kiln 103, along with feedstock material provided therein. According to one example, the concentric pipe assemblies 108,110 and 109,111 may together define a drive axle that rotates the kiln 103. For example, the concentric pipe assemblies 108,110 or 109,111 may be driven by a motor gear and chain drive. Alternatively, the concentric pipe assemblies 108,110 and 109,111 may be driven by other mechanisms. According to one example, the concentric dual pipe design reduced an opportunity for the external or outer pipe surface to be exposed to high heat levels. Therefore, the surface temperature of outer pipes 110,111 remain at generally safe levels for human interaction. One of ordinary skill in the art will readily appreciate that various drive mechanisms may be employed to rotate the kiln 103.

According to one example, the rotary kiln 103 may include first plates 112a-112b mechanically coupled to the body 104 and end 105. According to one example, the first plates 112a-112b may structurally reinforce the end 105 and may function to mix or transport the feedstock material as the kiln 103 rotates. Additionally, the rotary kiln 103 may include second plates 113a-113b mechanically coupled to the body 104 and end 106. According to one example, the second plates 113a-113b may structurally reinforce the end 106 and may function to guide the product material out of the kiln 103 during rotation. According to one example, the first plates 112a-112b and the second plates 113a-113b may be mechanically coupled via welding, fasteners, epoxy, or the like. According to one example, the first plates 112a-112b and the second plates 113a-113b may be mechanically coupled along a radial direction within the rotary kiln 103. According to one example, the rotary kiln 103 may include ribs or rings 114a-114c coupled to the body 104 to add structural rigidity, thereby preventing deformation due to high temperatures or process material load during operation. According to one example, the rings 114a-114c may include steel reinforcement rings that are mechanically coupled to an outer circumference of the body 104. According to one example, the rings 114a-114c may be mechanically coupled via welding, fasteners, epoxy, or the like.

According to one example, the rotary kiln 103 may include a plurality of paddles 115 mechanically coupled to an interior surface of the body 104. According to one example, the paddles 115 may be arranged and angled such that the feedstock material entering the rotary kiln 103 has maximum contact with the interior surface of the body 104. According to one example, the paddles 115 may be arranged parallel to the rotation axis of the kiln 103 or at an angle relative thereto. According to one example, the paddles 115 may guide the feedstock or product material from the feed end 105 to the discharge end 106 of the kiln 103 during rotation. According to one example, the paddles 115 are mechanically coupled to the interior of the body 104. For example, the paddles 115 may be welded to the interior of the body 104 of the kiln 103. According to one example, the paddles 115 may be sized and oriented to mix and agitate solid-state materials. According to one example, limiting dimensions may promote mixing the process material while ensuring heat transfer through maximizing contact with the heated body 104 of the rotary kiln 103. For example, the dimensions may be limited such that a height of the paddles 115 is approximately 2 inches in height and up to one foot in length. According to one example, the paddles 115 may mix the feedstock material to ensure contact between the process material and the heated body 104 of the rotary kiln 103. In other words, the paddles 115 may be designed or dimensioned to support efficient heat transfer to the process material. Throughout this disclosure, process material refers to feedstock material or product material. For simplicity of illustration, the paddles 115 are not depicted in any figures beyond FIG. 1.

According to one example, process material may be loaded into or extracted from the rotary kiln from either end 105,106. According to one example, the feed screw housing and the extraction screw housing have an upper portion removed over a length that extends into the rotary kiln 103 such that a remaining lower portion of these structures form a scoop that pushes out process material or catches falling process material as the kiln 103 rotates. The technology allows the kiln 103 to be emptied of product material when the extraction screw rotates to convey the process material that accumulates in the scoop area. According to one example, the second plates 113a-113b lift product material from inside the kiln 103 and deposit the product material over the scoop 704 provided in the extraction screw housing 206 that extends into the rotary kiln 103 from which the top half of the extraction screw housing 206 has been removed. According to one example, the feed screw and the extraction screw may be rotated in opposite directions to feed or extract process material from either end 105,106. Additionally, the technology contemplates employing multiple screws and corresponding housings at a single end 105,106. An ability to unload the kiln 103 from either end 105,106 may make a timing of batch processing more precise.

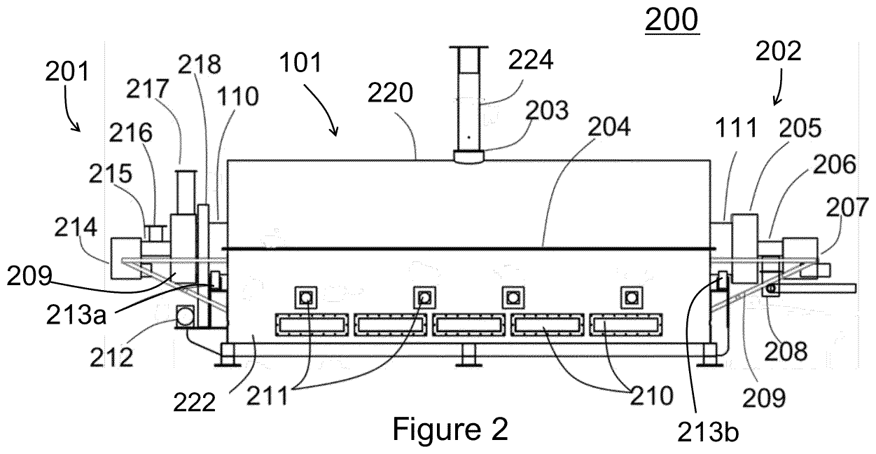

FIG. 2 illustrates an exterior side view of an apparatus 200 having an outer housing 101, a feed screw assembly 201, and an extraction screw assembly 202 according to one example of the technology. According to one example, the outer housing 101 may include a hinge 204 that pivotally couples an upper outer housing 220 and a lower outer housing 222. According to one example, the upper outer housing 220 and the lower outer housing 222 may be lined with refractory insulation 102 (not shown). According to one example, the upper outer housing 220 may include an exhaust stack or pipe 224 that is mechanically coupled to a connector flange 203. According to one example, the exhaust stack 224 transports air from inside the outer housing 101 to outside the outer housing 101. According to one example, the exhaust stack 224 may include a damper, a gas quench, and a filtration system (not shown). According to one example, the damper may function to regulate gas flow or control a volume of exhaust air. According to one example, the gas quench may function to cool the expelled air. For example, hot gas exiting the rotary kiln 103 may be quenched by inlet air prior to filtration. According to one example, the quenched air may be released to the atmosphere by an induction fan (not shown). According to one example, the filtration system may function to filter the expelled air. For example, the filtration system may include filters that remove particulate matter from the expelled air. Furthermore, exhaust gases expelled from the rotary kiln 103 may include sufficient temperature and volume to preheat materials prior to entering the kiln 103. According to one example, collected waste heat may be used to preheat or otherwise treat the process material. One of ordinary skill in the art will readily appreciate that the exhaust stack 224 and the connector flange 203 may be provided in the lower outer housing 222. According to one example, all contact surfaces may be constructed from high temperature alloys and may include flanged connections for the feed system, the stack system, and the product discharge system.

According to one example, the lower outer housing 222 may include first ports 210 or second ports 211. According to one example, the first ports 210 may be employed with electrical heating elements while the second ports 211 may be employed with gas fired burners. For example, the first ports 210 may allow access to electrical heating elements provided within the outer housing 101. Likewise, the second ports 211 may allow access to gas burners provided within the outer housing 101. According to one example, the electrical heating elements may be mechanically mounted within the outer housing 101 such that electrical connections may be accessed through the first ports 210. In addition, or alternatively, the gas burners may be mechanically mounted within the outer housing 101 such that the gas connections may be accessed through the second ports 211. According to one example, the electrical heating elements or gas burners may be positioned within the outer housing 101 to provide thermal energy needed to generate a desired temperature profile along the kiln 103. For example, the electrical heating elements and/or gas burners may be positioned to optimize kiln processing conditions.

According to one example, the apparatus 200 may include a drive assembly that rotates the kiln 103. For example, the drive assembly may include a motor 212, a housing 218, a chain provided within the housing 218, and stabilizing rollers 213a,213b. According to one example, the stabilizing rollers 213a,213b are provided on opposite ends 105,106 of the outer housing 101 to support corresponding ones of the concentric pipe assemblies 108,110 and 109,111. According to one example, the annular outer pipes 110,111 that are mechanically coupled to the kiln 103 may rest on corresponding stabilizing rollers 213a,213b. According to one example, the annular outer pipes 110,111 may function as axles to enable rotation of the kiln 103. According to one example, the drive assembly may include a chain drive that rotates the kiln 103 via a toothed wheel mechanically coupled to the pipe 110. One of ordinary skill in the art will readily appreciate that other drive assemblies may be employed.

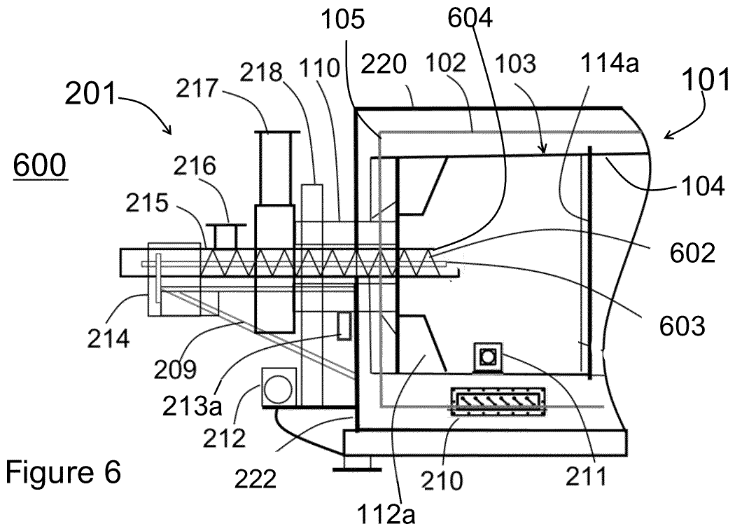

According to one example, the apparatus 200 may include a feed screw assembly 201 and an extraction screw assembly 202 to transport process material into and out of the kiln 103. According to one example, the feed screw assembly 201 may be fluidly coupled to the kiln 103 via the concentric pipe assembly 108,110. According to one example, the feed screw assembly 201 and the concentric pipe assembly 108,110 may be fitted with an inert gas charged seal to render connections between these components substantially airtight. According to one example, the inlet pipe 108 receives a feed screw housing 215 having a feed screw 602 as illustrated in close-up in FIG. 6. According to one example, the feed screw housing 215 is sealed to prevent air from entering the kiln 103 since air penetration may cause an adverse reaction such as an explosion. According to one example, a drive unit 214 rotates the feed screw 702 via a shaft 603 to transport material into the kiln 103. According to one example, the drive unit 214 may include a motor.

According to one example, the feed screw assembly 201 may include a feed bin or feed hopper 401 that is mechanically coupled to a flange 216. According to one example, the feed hopper 401 is provided to supply material into the feed screw housing 215 through the flange 216 for delivery into the kiln 103 via rotation of the feed screw 602. According to one example, the feed screw assembly 201 may include a gas plenum that is mechanically coupled to a flange 217. According to one example, an annular space may be provided between the inlet pipe 108 and the first outer pipe 110 to allow outflow of gas from the rotary kiln 103. According to one example, the gas plenum is provided to remove exhaust from the kiln 103. According to one example, the gas plenum may include a filtration system that removes particulates from the exhaust. According to one example, the feed screw assembly 201 may be fixedly attached to the outer housing 101 using a bracket 209.

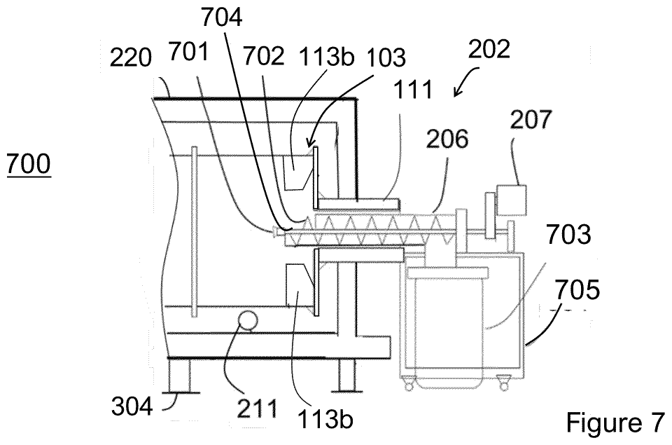

According to one example, the extraction screw assembly 202 may be fluidly coupled to the kiln 103 via the concentric pipe assembly 109,111. According to one example, the extraction screw assembly 202 and the concentric pipe assembly 109,111 may be fitted with an inert gas charged seal to render connections between these components substantially airtight. According to one example, the extractor screw assembly 202 includes the discharge or extraction screw housing 206, the extraction screw drive motor 207, a material discharge opening 208, and a gas sampling outlet (not shown). These components may be fixedly mounted onto the outer housing 101 using bracket 209. According to one example, the outlet pipe 109 receives an extraction screw housing 206 having an extraction screw 702 as illustrated in close-up in FIG. 7. According to one example, a drive unit 207 rotates the extraction screw 702 to transport material out of the kiln 103. According to one example, the drive unit 207 may include a motor. According to one example, the extraction screw assembly 202 may include a catchment container 703 that is mechanically coupled to a material discharge opening 208. According to one example, the catchment container 703 is provided to receive material extracted from the kiln 103 via the feed screw 702. According to one example, the extraction screw assembly 202 may include a gas plenum that is mechanically coupled to a flange 205. According to one example, an annular space may be provided between the outlet pipe 109 and the second outer pipe 111 to allow outflow of gas from the rotary kiln 103. According to one example, the gas plenum is provided to remove exhaust from the kiln 103. According to one example, the gas plenum may include a filtration system that removes particulates from the exhaust. According to one example, the product material extracted from the kiln 103 may remain substantially at the kiln temperature. According to one example, a cooling water jacket (not shown) may be provided to cool the extracted product material to a desired temperature. For example, water may be pumped through a radiator or a fan to remove the heat. According to another example, the extraction screw 702 or the extraction screw housing 206 may be adapted to cool the extracted material. According to one example, the extraction screw assembly 202 may be fixedly attached to the outer housing 101 using a bracket 209.

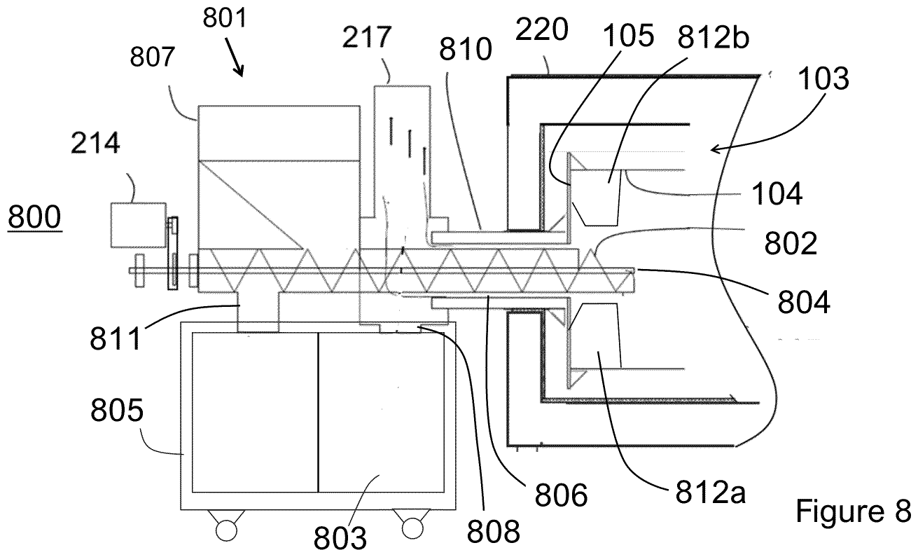

According to alternative examples illustrated in FIGS. 7 and 8, the feed screw assembly 201 and the extraction screw assembly 202 may be mounted on portable carts rather than being permanently affixed to the outer housing 101. According to one example, a portable feed screw assembly 201 and a portable extraction screw assembly 202 facilitate component swapping when the feed hopper 401 becomes empty or the catchment container 703 becomes full. According to one example, portable carts facilitate detachment of the feed screw assembly 201 or the extraction screw assembly 202 from the rotary kiln 103. According to one example, the feed screw assembly 201 and the extraction screw assembly 202 are fitted into the corresponding annular inlet pipe 108 or outlet pipe 109 to fluidly communicate with the cavity of the rotary kiln 103.

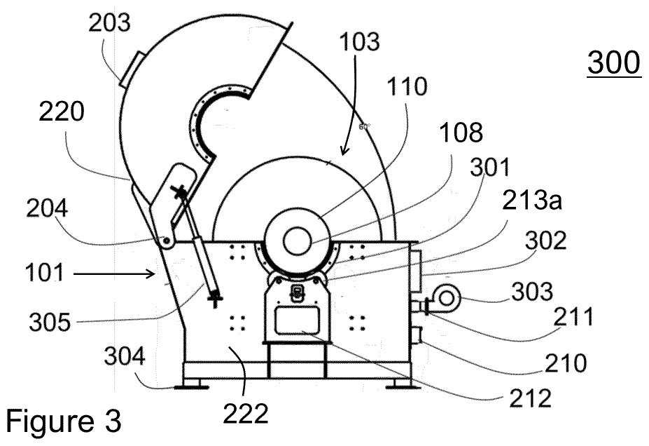

FIG. 3 illustrates an end view of an apparatus 300 according to one example of the technology with the outer housing 101 provided in an open configuration and the feed screw assembly 201 removed to facilitate illustration. According to one example, the upper outer housing 220 is pivotably coupled to the lower outer housing 222 via a hinge 204. According to one example, the hinge 204 may extend along a side of the outer housing 101. According to one example, a hydraulic assisted lift mechanism 305 is provided to transition the outer housing 101 between closed and open configurations. According to one example, the hydraulic assisted lift mechanism 305 is mechanically coupled to the upper outer housing 220 and the lower outer housing 222. According to one example, the hydraulic assisted lift mechanism 305 is provided to reduce an effort needed to pivot the upper outer housing 220 relative to the lower outer housing 222 while opening or closing the outer housing 101. According to one example, the hydraulic assisted lift mechanism 305 is provided to maintain the outer housing 101 in an open position. According to one example, the outer housing 101 may be opened to provide direct access to the rotary kiln 103 such as for inspection and maintenance. Additionally, the outer housing 101 may be opened to enable installation or removal of the kiln 103 therefrom. According to one example, the outer housing 101 may include legs 304 that minimize direct contact with a floor surface. According to one example, a length of the legs 304 may be adjusted to set a resting angle for the outer housing 101. For example, the length of the legs 304 may be adjusted to level the outer housing 101. Alternatively, the length of the legs 304 may be adjusted to impose a desired pitch angle to the outer housing 101.

According to one example, the stabilizing rollers 213a are illustrated to support the concentric pipe assembly 108,110. According to one example, the first outlet pipe 110 is mechanically coupled to the kiln 103 and rests on stabilizing rollers 213a coupled to the outer housing 101. According to one example, the first outlet pipe 110 functions as an axle to enable rotation of the kiln 103. According to one example, the drive assembly 212 may include a chain drive that rotates the kiln 103 via a toothed wheel mechanically coupled to the pipe 110 (not shown). According to one example, the concentric pipe assembly 108,110 enables a surface of the first outlet pipe 110 to be partially thermally isolated from the hot kiln surfaces. Thermal isolation allows the first outlet pipe 110 to remain below a surface temperature of the body 104 and ends 105,106 of the kiln 103. According to one example, the concentric pipe assembly 108,110 may include a gas seal 301 provided between the first outlet pipe 110 and the outer housing 101 to prevent passage of vapor or gas between these components. In other words, the gas seal 301 may fluidly isolate the kiln 103 from unintended leakage of vapor or gases into or out of the kiln 103. According to one example, the concentric pipe assembly 109,111 may include a similar gas seal.

According to one example, a burner 303 is illustrated coupled to port 211. According to one example, the burner 303 is provided to heat the rotary kiln 103. According to one example, the burner 303 may be fired by gas or liquid fuels to provide indirect heating to the rotary kiln 103. According to one example, a control panel 302 may be provided to interface with a controller that controls operation of the apparatus 300. For example, the control panel 302 may enable users to control kiln rotation characteristics such as direction and speed, among other characteristics. Furthermore, the control panel 302 may control heat application and heat duration for the kiln 103. For example, heat duration may be determined based on data obtained from heat sensors located within the apparatus 300. Still further, the control panel 302 may regulate a current level supplied to each heating element to control a temperature along a corresponding part of the rotary kiln 103. According to one example, heat sensors may be distributed throughout the outer housing 101, proximate to the kiln 103. According to one example, the control panel 302 may control a rotation direction or a rotation speed of the screws associated with the feed screw assembly 201 and the extraction screw assembly 202. According to one example, the control panel 302 may control a material feed rate and the temperature output from the heating elements to maintain a desired temperature profile target to generate a desired distribution of products within the kiln 103. One of ordinary skill in the art will readily appreciate that the control panel 302 may control other aspects or features of the apparatus 300.

According to one example, the control panel 302 may be mounted on the outer housing 101 or at another location. According to one example, the control panel 302 may allow manual operation, automated operation, or partially automated operation. According to one example, the control panel 302 may include a manual override option to allow intervention during a failure event. According to one example, the control panel 302 allows temperature control within the rotary kiln 103. For example, the control panel 302 may enable temperature control by zone along a length of the kiln 103. According to one example, the control panel 302 may support various thermal zones within the kiln 103, each having characteristics that are particular to a given heat value. According to one example, the zones may sequentially follow a feed direction of the feedstock material. According to one example, the approximate boundaries between adjacent zones may be identified during operation of the kiln 103. For example, the boundaries may be established based on operating conditions of the kiln 103 that are determined by a composition of the deposited feedstock material, a rate at which the feedstock material is deposited, an amount of feedstock material deposited, a tilt angle of the body 102, and a spin rate of the kiln 103, among other operating conditions. According to one example, the control panel 302 may adjust the zone conditions by varying the current supplied to electrical heating elements mounted inside the case along the length of the kiln. These elements may be installed inside the refractory lined housing under or near the rotary kiln body or wrapped directly around the kiln body.

According to one example, a plurality of burners 303 may be coupled to ports 211 provided at the outer housing 101. According to one example, burners 303 may generate heated air that circulates between the outer housing 101 and rotary kiln 103. According to one example, a space is defined between the kiln 103 and the refractory insulation 102 of sufficient dimension to allow circulation of heated air around the kiln body 104. Exhaust from the burners 303 may exit the outer housing 101 through a damper provided in an exhaust stack 224 coupled to the flange 203.

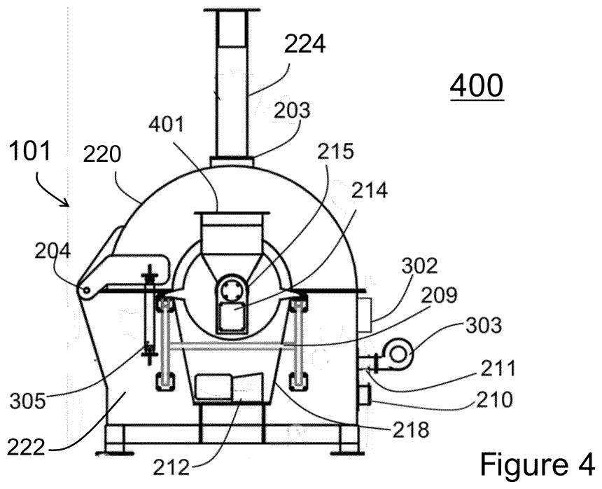

FIG. 4 illustrates an end view of an apparatus 400 according to one example of the technology with the outer housing 101 provided in a closed configuration and the feed screw assembly 201 installed via bracket 209. According to one example, feedstock material may be placed into the feed hopper 401. According to one example, a force of gravity or a mechanical apparatus may be used to deposit the feedstock material into the feed screw housing 215. According to one example, the control panel 302 may activate a screw auger provided within the feed screw housing 215 to convey the feedstock material into the rotary kiln 103. According to one example, the control panel 302 may activate a screw auger drive motor 214 to activate the screw auger. According to one example, the flange 203 may be mechanically coupled to the exhaust stack 224 that includes a damper.

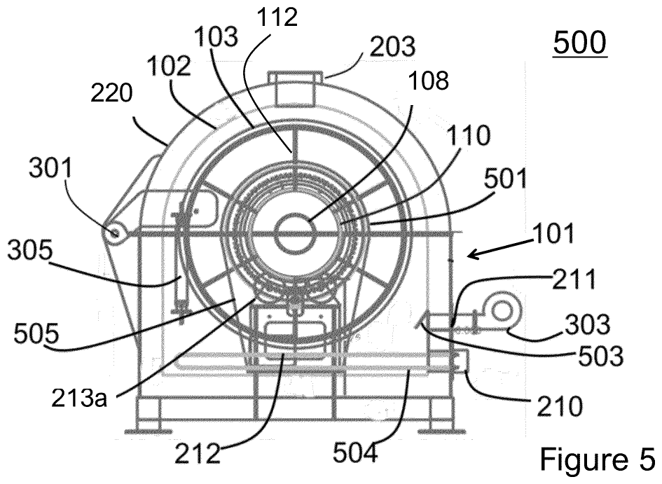

FIG. 5 illustrates a cross sectional end view of the apparatus 400 illustrated in FIG. 4. According to one example, the kiln 103 is supported on both ends by the first outer pipe 110 and the second outer pipe 111 (not shown). According to one example, the first outer pipe 110 is supported by a pair of stabilizing rollers 213a. According to one example, an annular space is provided between the inlet pipe 108 and the feed screw housing 215 to form a flow path for exhaust gas from the rotary kiln 103. According to one example, a toothed wheel 501 is provided to engage a drive chain 505 that is powered by drive motor 212 to rotate the kiln 103. According to one example, an electrical heating element 504 may be provided within the outer housing 101. For example, the electrical heating element 504 may be provided in a horizontal orientation beneath the kiln 103. Still further, the electrical heating element 504 may be oriented at an angle that is substantially perpendicular relative to the rotation axis of the kiln 103. According to one example, the refractory insulation 102 may retain heat within the outer housing 101. With respect to electrical heating, a plurality of heating elements 504 may be placed around the kiln 103 between the outer housing 101 and the rotary kiln 103. According to one example, load requirements will determine placement and quantity of the heating elements 504. According to one example, the apparatus 500 may include temperature sensors positioned along a length of the rotary kiln 103. According to one example, the control panel 302 may monitor temperature data obtained from the temperature sensors. According to one example, the control panel 302 may activate or deactivate selected heating elements to maintain a desired temperature characteristic within the kiln 103.

According to one example, the burner 303 may include a blower such as an air blower. For example, the burner 303 may include a fan driven burner 303. According to one example, the fan driven burner 303 may operate as a cooling fan when heat is not applied via the burner 303. According to one example, the port 211 facilitates mechanical and electrical connections 210 of resistive heating elements to indirectly heat the rotary kiln 103. According to one example, a hinged closure flap 503 may be coupled to the port 211. According to one example, the blower associated with the burner 303 may be powered by electricity, gas, battery, or the like. According to one example, the hinged closure flap 503 may be coupled to an interior side of the port 211. According to one example, the hinged closure flap 503 may remain closed when the blower associated with the burner 303 is off and may open when the blower associated with the burner 303 is on. For example, air expelled by the blower associated with the burner 303 may cause the hinged closure flap 503 to open. According to one example, the control panel 302 may mechanically close the hinged closure flap 503 to maintain elevated temperatures within the outer housing 101. According to one example, the control panel 302 may activate the blower associated with the burner 303 to lower the temperature within the outer housing 101. According to one example, the burner 303 may be activated to generate heat. According to one example, the burner 303 may employ natural gas, kiln product gas, vaporized product liquids, imported liquid fuels, or producer gas from partial oxidation of all or a portion of the char produced to heat the kiln 103. One of ordinary skill in the art will readily appreciate that a plurality of burners 303 may be coupled to the outer housing 101.

According to one example, a damper may be provided within the stack 224 coupled to flange 203. According to one example, the control panel 302 may open or close the damper. For example, the control panel 302 may close the damper during a heating operation to retain heat around the rotary kiln 103. Otherwise, the control panel 302 may open the damper during cool down periods to introduce ambient or outside air into the outer housing 101 around the kiln 103.

FIG. 6 illustrates a close-up side view of the feed screw assembly 201 fluidly coupled to the kiln 103 via the concentric pipe assembly 108,110. According to one example, the feed screw assembly 201 and the concentric pipe assembly 108,110 may be fitted with an inert gas charged seal to render connections between these components substantially airtight. According to one example, the inlet pipe 108 receives the feed screw housing 215 that includes the feed screw 702 therein. According to one example, an upper distal end of the feed screw housing 215, opposite the drive unit 214, has a portion removed to form a scoop 604 that allows material transported by the screw 602 to enter the kiln 103 therethrough. According to one example, a shaft 603 is provided to structurally support the screw 602. According to one example, the shaft 603 may be solid or hollow. A hollow shaft 603 provides a pathway for a fluid such as a gas to be injected into the kiln 103 to support certain chemical processes. For example, the hollow shaft 603 may enable steam injection into the kiln 103. According to one example, if carbon particles are present, the steam may react with the carbon particles at elevated temperatures to form activated carbon. According to one example, the drive unit 214 is mechanically coupled to the shaft 603 and rotates the feed screw 602 via the shaft. In other words, the feed screw 602 rotates with the shaft to transport material into the kiln 103. According to one example, the feedstock material travels along the feed screw housing 215 upon appropriate rotation of the feed screw 602 and exits the scoop 604 into the kiln 103. According to one example, the first plates 112 are shaped to mix the feedstock material deposited into the kiln 103. According to one example, a plurality of first plates may be provided at the end plate 106 to mix the feedstock material when deposited. For example, the plurality of first plates may include six evenly spaced at approximately 60 degrees, as illustrated in FIG. 5, in order to mix the feedstock material. One of ordinary skill in the art will readily appreciate that any number of first plates may be used.

FIG. 7 illustrates a close-up side view of the extraction screw assembly 202 provided on a movable cart 705 and fluidly coupled to the kiln 103 via the concentric pipe assembly 109,111. According to one example, the extraction screw assembly 202 and the concentric pipe assembly 109,111 may be fitted with an inert gas charged seal to render connections between these components substantially airtight. According to one example, the outlet pipe 109 receives the extraction screw housing 206 that includes the extraction screw 702 therein. According to one example, an upper distal end of the feed screw housing 206, opposite the drive unit 207, has a portion removed to form a scoop 704 that allows material transported through the kiln 103 to deposit onto the screw 702. According to one example, the shaft 701 is provided to structurally support the screw 702. According to one example, the shaft 701 may be solid or hollow. A hollow shaft 701 may provide a pathway for a fluid such as a gas to be injected into the kiln 103 to support certain chemical processes. For example, the hollow shaft 701 may enable steam injection into the kiln 103.

According to one example, a drive unit 207 may be a motor that is mechanically coupled to the shaft 701 to rotate the extraction screw 702 via the shaft 701. In other words, the extraction screw 702 transports material deposited from the kiln 103 when the shaft is turned in an appropriate direction. According to one example, the process material is deposited on the scoop 704 and travels along the feed screw housing 206 upon appropriate rotation of the extraction screw 702. According to one example, the extraction screw assembly 202 may include a catchment container 703 mechanically coupled to a material discharge opening. According to one example, the catchment container 703 is provided to receive material extracted from the kiln 103 via the feed screw 702. According to one example, the extraction screw assembly 202 may include a gas plenum that is mechanically coupled to a flange. According to one example, an annular space may be provided between the outlet pipe 109 and the second outer pipe 111 to allow outflow of gas from the rotary kiln 103. According to one example, the gas plenum is provided to remove exhaust from the apparatus. According to one example, the gas plenum may include a filtration system that removes particulates from the exhaust.

According to one example, the material extracted from the kiln 103 may remain substantially at a kiln temperature. According to one example, a cooling water jacket (not shown) may be provided to cool the extracted material. For example, water may be pumped through a radiator or a fan to remove the heat. According to another example, the extraction screw 702 or the extraction screw housing 206 may be adapted to cool the extracted material. According to one example, the second plates 113 are shaped to extract the process material from the kiln 103. According to one example, the second plates 113 extract product material from the kiln 103 during kiln rotation, with the extracted material falling onto the scoop 704 via gravity. According to one example, the product material within the scoop 704 is conveyed by the screw 702 to a discharge port where gravity or a mechanical mechanism remove the product material to a suitable container positioned below the port such as the catchment container 703. A plenum captures gas exiting the kiln 103 through the annular space between the extraction screw housing 206 and the inner pipe 111. According to one example, a plurality of second plates may be provided to remove the process material from the kiln 103 and deposit the removed material onto the scoop 704 for transport to the catchment container 703. For example, the plurality of second plates may include six evenly spaced at approximately 60 degrees to extract the product material. One of ordinary skill in the art will readily appreciate that any number of second plates may be used.

FIG. 8 illustrates a close-up side view of the bi-directional screw assembly 801 provided on a movable cart 805 and fluidly coupled to the kiln 103 via the concentric pipe assembly. According to one example, the bi-directional screw assembly 801 and the concentric pipe assembly may be fitted with an inert gas charged seal to render connections between these components substantially airtight. According to one example, bi-directional pipe 809 receives the bi-directional screw housing 806 that includes the bi-directional screw 802 therein. According to one example, the bi-directional screw 802 may be operated in reverse directions to deposit or remove process material into or from the rotary kiln 103. For example, the drive unit 214 may determine the rotational direction of the bi-directional screw 802. For example, the drive unit 214 may include a drive motor that changes a rotation direction of the bi-directional screw to load or unload the rotary kiln 103.

According to one example, an upper distal end of the bi-directional screw housing 806, opposite the drive unit 214, has a portion removed to form a scoop 804. According to one example, the scoop 804 allows feedstock material transported by the screw 802 to enter the kiln 103 therethrough. Furthermore, the scoop 804 allows product material transported through the kiln 103 to deposit onto the screw 802. According to one example, the shaft 804 is provided to structurally support the bi-directional screw 802. According to one example, the shaft 804 may be solid or hollow. A hollow shaft 804 may provide a pathway for a fluid such as a gas to be injected into the kiln 103 to support certain chemical processes. For example, the hollow shaft 804 may enable steam injection into the kiln 103.

According to one example, the rotary kiln 103 may include plates 812a-812b mechanically coupled to the body 104 and end 105. According to one example, the plates 812a-812b may structurally reinforce the end 105 and may function to mix or transport the feedstock material as the kiln 103 rotates. Furthermore, the plates 812a-812b may function to guide the product material out of the kiln 103 during rotation. According to one example, the plates 812a-812b may be mechanically coupled via welding, fasteners, epoxy, or the like. According to one example, the plates 812a-812b may be mechanically coupled along a radial direction within the rotary kiln 103.

According to one example, the bi-directional screw assembly 801 may include a feed hopper 807 that is mechanically coupled to a flange. According to one example, the feed hopper 807 is provided to supply material into the bi-directional screw housing 806 for delivery into the kiln 103 via the bi-directional screw 802. According to one example, the bi-directional screw assembly 801 may include a gas plenum that is mechanically coupled to a flange 217. According to one example, an annular space may be provided between a bi-directional pipe 808 and outer bi-directional pipe 810 to allow outflow of gas from the rotary kiln 103. According to one example, the gas plenum is provided to remove exhaust from the kiln 103. According to one example, the gas plenum may include a filtration system that removes particulates from the exhaust.

According to one example, the bi-directional screw assembly 801 may include a catchment container 803 that is mechanically coupled to a material discharge opening 808. According to one example, the catchment container 803 is provided to receive material extracted from the kiln 103 via the bi-directional screw 802. According to one example, the bi-directional screw assembly 801 may include a gas plenum that is mechanically coupled to a flange. According to one example, an annular space may be provided between the bi-directional pipe 809 and the outer bi-directional pipe 811 to allow outflow of gas from the rotary kiln 103. According to one example, the gas plenum is provided to remove exhaust from the kiln 103. According to one example, the gas plenum may include a filtration system that removes particulates from the exhaust. According to one example, the product material extracted from the kiln 103 may remain substantially at the kiln temperature. According to one example, a cooling water jacket (not shown) may be provided to cool the extracted product material to a desired temperature. For example, water may be pumped through a radiator or a fan to remove the heat. According to another example, the bi-directional screw 802 may be adapted to cool the extracted material. According to one example, the bi-directional screw assembly 801 may be fixedly attached to the outer housing 101 using a bracket.

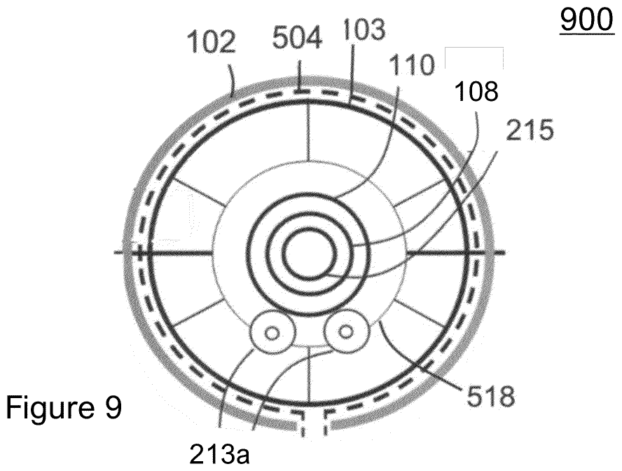

FIG. 9 illustrates a cross-sectional end view of the rotary kiln 103 with a reinforcing end plate 518 and the concentric pipe assembly 108,110 according to one example of the technology. The electrical heating elements 504 are wrapped around the outer wall of the rotary kiln 103. According to one example, the heating elements 504 are wrapped with refractory insulation 102. According to one example, the stabilizing rollers 213a stabilize the annular inlet pipe 110 that serves as an axle for rotation of the rotary kiln 103. According to one example, the feed screw housing 215 is positioned inside pipe 108 and may be permanently affixed to the outer housing 101 by a bracket 109. In an alternative example, the feed screw housing 215 and associated components may be mounted on a cart to facilitate removal from the rotary kiln 103.

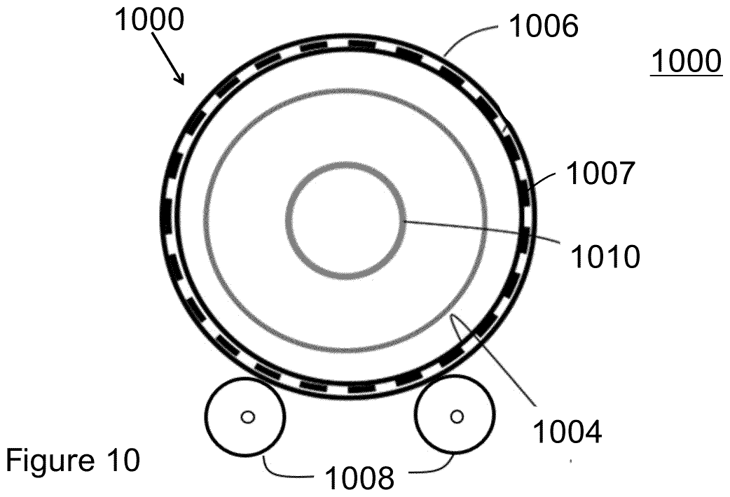

FIG. 10 illustrates an end view of an alternative kiln 1000 having a modified drive system and support mechanism for larger scale kilns of approximately 8-foot diameter or greater according to one example of the technology. Larger scale kilns 1000 inherently include larger mass that renders the concentric pipe assembly non-ideal for supporting weight. For example, one issue with supporting weight using the concentric pipe assembly is that the pipes will need to be made larger to support greater weight. Larger concentric pipes may increase an entry aperture into a kiln that may adversely affect operation conditions. Furthermore, larger concentric pipes may be bulky and may complicate structural connections around the kiln.

A preferred modification for a larger scale kiln 1000 includes providing a weight bearing structure on a body 1004 of the kiln 1000. According to one example, the weight of a larger kiln 1000 and the kiln load may be supported through the outer diameter of the body 1004, rather than through annular pipes (not shown). According to one example, a support ring 1006 may be coupled to spacers 1007 that are coupled to an outer circumference of the body 1004 of the rotary kiln 1000. According to one example, the support ring 1006 may rest upon stabilizing rollers 1008. According to one example, a gear 1010 may be coupled to the rotary kiln 1000 to provide rotation.

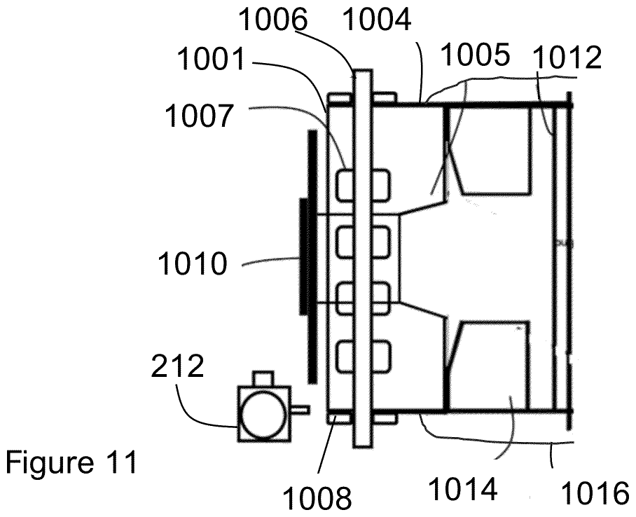

FIG. 11 illustrates a close-up side view of the alternative kiln 1000 illustrated in FIG. 10. The alternative kiln 1000 includes a modified drive system and support mechanism for larger scale kilns of approximately 8-foot diameter or greater according to one example of the technology. According to one example, the weight of a larger kiln 1000 and the kiln load may be supported through the outer diameter of the body 1004, rather than through annular pipes (not shown). According to one example, a support ring 1006 may be coupled to spacers 1007 that are coupled to an outer circumference of the body 1004 of the rotary kiln 1000. According to one example, the support ring 1006 may rest upon stabilizing rollers 1008. According to one example, a gear 1010 may be coupled to the rotary kiln 1000 to provide rotation. According to one example, the gear 1010 engages a chain (not shown) that is driven by a drive motor 212. This arrangement allows the weight of the kiln 1000 to be supported by the body 1004 of the kiln 1000, instead of by pipes coupled to an end 1001 of the kiln 1000. According to one example, pipe access is internal via element 1005. According to one example, the larger diameter kiln 1000 may include ribs or rings 1012 coupled to the body 1004 to add structural rigidity, thereby preventing deformation due to high temperatures or process material load during operation. According to one example, the rotary kiln 1000 may include plates 1014 mechanically coupled to the body 1004 and end 1001. According to one example, the plates 1014 may structurally reinforce the end 1001 and may function to mix or transport the feedstock material as the kiln 103 rotates. Additionally, the rotary kiln 1000 may include second plates mechanically coupled to the body 1004 and the opposite end. According to one example, the second plates may structurally reinforce the opposite end and may function to guide the product material out of the kiln 1000 during rotation. According to one example, the plates 1014 and the second plates may be mechanically coupled via welding, fasteners, epoxy, or the like. According to one example, an outer housing 1016 may be provided to avoid encapsulating the support ring 1006 coupled to spacers 1007 that are coupled to an outer circumference of the body 1004 of the rotary kiln 1000.

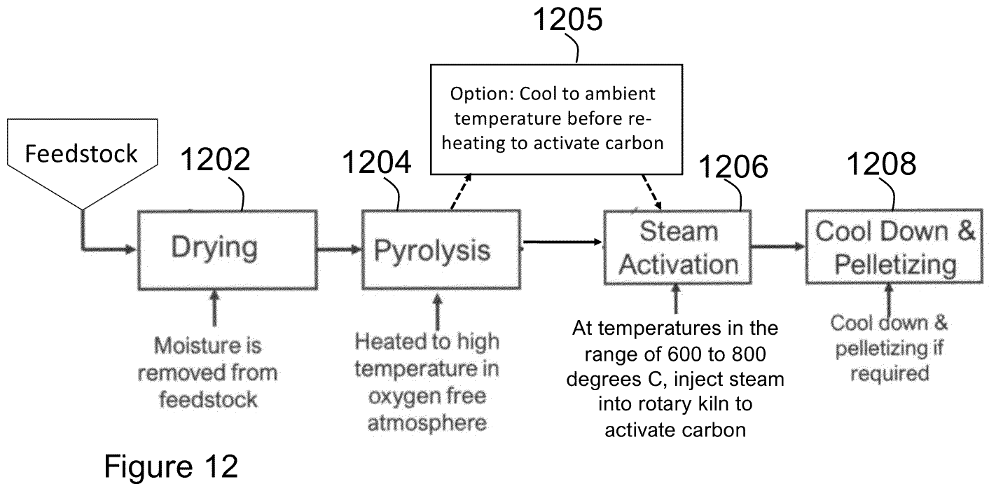

FIG. 12 illustrates a method 1200 of producing activated carbon from any material that capable of making charcoal according to one example of the technology. For example, materials capable of making charcoal include woody biomass, coconut shells, biochar, or the like. In operation 1202, the feedstock process material is dried. In operation 1204, the dried process material undergoes pyrolysis. In operation 1205, an option is available to cool the process material to ambient temperature before re-heating to activate carbon. In operation 1206, steam is injected into the kiln to steam activate the carbon at high temperature. In operation 1208, the product material is cooled down and optionally pelletized. According to one example, the present technology enhances production of activated carbon through effective sealing of the kiln interior so that the flow of gasses into or out of the kiln may be controlled. According to one example, activated carbon production begins by transporting the dried starting material such as granulated biochar or carbon black via the feed screw into the pre-heated rotary kiln. When operating in batch mode, process material is pyrolyzed by contact with the hot rotary kiln walls causing decomposition with some of the carbon lost as a result. When the process material temperature reaches approximately 700 degrees C., steam is injected through the hollow shaft of the discharge screw. According to one example, a combination of pyrolysis and high temperature steam treatment opens millions of small pores between the carbon atoms, creating a highly porous material with a large surface area.

The present technology further has application in replacing fossil energy in utility boilers. Indirect heating described in this technology offers an enhanced way of achieving reliable production of medium to high energy content gases, as opposed to directly heated pyrolyzers. To be clear, direct heating produces a relatively low energy content fuel gas such as in sub-stoichiometric injection of air for partial combustion of green fuels to provide the endothermic heat required for pyrolytic conversion to gaseous fuel. According to one example, indirect heat transfer produces a medium to high energy content gaseous product that has both economic and process configuration advantages, from downstream lower equipment cost to higher energy efficiency. According to one example, FIG. 8 illustrates detail of a path taken by process material removed from the rotary kiln by reversal of the direction of rotation of the feed screw. In this case, the process material is discharged outside the kiln through a port and the rotary kiln gas is extracted via a plenum.

The technology further has application in the decentralized recycling of plastic waste. Indirect pyrolysis of plastics generates a hydrocarbon rich gaseous product that, depending on the severity of thermal cracking, may then be condensed and processed into transportation fuels or blendable feedstocks with the non-condensables being used in low pollution emitting burners to provide the endothermic heat of pyrolysis indirectly. The technology offers a key component in such decentralized systems that minimize generation of green-house gases.

Furthermore, the present technology may be used to recycle plastics where the severity of thermal cracking of the plastics is conducted so as to optimize the hydrocarbon product yield of gaseous species. According to one example, the gaseous species may be converted downstream to satisfy circular economy goals and standards. For example, thermal cracking may be employed to produce the olefins needed to make new plastics, thereby closing the loop on plastics production. Alternatively, the hydrocarbon rich vapor phase products may be reformed to make synthesis gas and produce products ranging from fuels to specialty oils and waxes.

In addition to managing plastic waste, the present technology may be used to recycle plastics by optimizing the severity of thermal cracking of waste plastics so as to produce a syn-crude that can be processed in existing petroleum refineries. This can be achieved optimally with a balancing of thermal and or steam cracking severity and the recycling of the heavy oil fraction produced such that all of the non-condensable fuel gases generated can be utilized optimally in providing the endothermic heat and or parasitic load required to operate the facility.

The present technology may be applied to process solids that require long residence times to perfect the quality of the products generated. According to one example, steam may be produced through heat recovery from the indirectly fired fuel gases used and the steam may be used to ensure volatiles, generated from feed stocks such as cultivated biomass and or biomass waste, are not severely cracked losing potential value as condensable by-products. It will be appreciated by persons skilled in the art that the present technology is not limited to what has been particularly shown and described herein. A variety of modifications and variations are possible in light of the teachings herein without departing from the scope and spirit of the invention.

Examples are described above with the aid of functional building blocks that illustrate the implementation of specified functions and relationships thereof. The boundaries of these functional building blocks have been arbitrarily defined herein for the convenience of the description. Alternate boundaries can be defined so long as the specified functions and relationships thereof are appropriately performed. While the foregoing illustrates and describes examples of this technology, it is to be understood that the technology is not limited to the constructions disclosed herein. The technology may be embodied in other specific forms without departing from its spirit. Accordingly, the appended claims are not limited by specific examples described herein.

What is claimed is:

1. An indirectly heated rotary kiln comprising:
an outer housing that includes an upper outer housing pivotably coupled to a lower outer housing;
a kiln having a body, a first end, and a second end that define a cavity, the kiln being dimensioned to fit within the outer housing;
a feed screw assembly coupled to the outer housing that transports feedstock into the kiln through the first end;
an extraction screw assembly coupled to the outer housing that removes product material from the kiln through the second end;
a heating system that elevates a temperature of the kiln; and
an electronic controller that controls kiln rotation speed, feed screw rotation speed, extraction screw rotation, and a temperature profile along a length of the kiln.

2. The indirectly heated rotary kiln according to claim 1, further comprising a motor drive and chain drive.
